(19) United States
(12) Patent Application Publication
(10) Pub. No.: US 2004/0165285 A1
(43) Pub. Date: Aug. 26, 2004

(54) Modular optical construction system, components and method

(76) Inventor: John Galpin, Isle of Man (GB)

Correspondence Address: Don W Bulson, Renner Otto Boisselle & Sklar, 19th Floor, 1621Euclid Avenue, Cleveland, OH, 44115, US

(21) Appl. No.: 10/472,775

(22) PCT Filed: Mar. 15, 2002
(86) PCT No.: PCT/GB02/01228

(30) Foreign Application Priority Data
Mar. 23, 2001 (GB) 0107374.1

(51) Int. Cl. G02B 7/02

(52) U.S. Cl. 359/819

(57) ABSTRACT

A general problem with optical component systems is the prevalence of two separate standards, the metric standard and the Imperial standard. Both standards arm well established and there is no prospect of one standard dominating in the forsceable future. In the metric standard, optical tables, breadboards and other items are provided with square grids having a 25 mm or 50 mm pitch. In the Imperial standard, the pitch is instead 1 or 2 inches. Optical rail systems, cage assembly systems and the like thus have to be specifically manufactured for each standard. The invention builds on the fact that in the metric system, the optical rods used have diameter of 12 mm (radius 6 mm), whereus in the Imperial system they have a diameter of ½ inch (radius ¼ inch). Based on this fact, the realisation has been made that the separation between the outer surfaces of two rods mounted on adjacent holes is almost the same for both standards for the special case of the comparison between 2 inch and 50 mm rod separation.

### BACKGROUND OF THE INVENTION

This invention relates to a modular optical construction system of the type used in laboratories and research departments, for example, to construct optical systems including various components such as light sources, mirrors, lenses and prisms, optical fiber components and so forth. The invention further relates to components for such systems, and to methods of constructing optical systems using such components.

It is well known to use optical tables or benches, on which components can be mounted. These typically have an array of threaded holes to which components can be attached. While these holes are at standard spacings, the components themselves may come from a variety of sources and there is no standard for compatibility. To link together a number of components from different suppliers may require adapters, riser blocks and so forth. Furthermore, there are two different standards for the holes in the tables. In the United States and certain other countries Imperial units are still used, as exemplified by the “fps” (“foot, pound, second”) measuring system. In optical systems based on Imperial units, the holes are usually one or two inches apart. In countries using the metric system the holes are twenty five millimetres or fifty millimetres apart. It is known to provide vertical posts which screw into the holes, to which components are clamped. These have a diameter of half an inch in an fps system and twelve millimetres in a metric system. The result is that components designed for use in the United States, for example, may not work in Europe and elsewhere. This means that two different sets of components have to be manufactured or that adapters have to be used. This adds to the cost and complexity of systems.

U.S. Pat. No. 3,945,600 [1] assigned to Spindler & Hoyer discloses a system using rods in which a mounting element in the form of a square plate has an aperture adjacent each corner so that four rods can be held in parallel array. To assist in assembly, the mounting elements are split in the regions of the openings.

U.S. Pat. No. 5,035,333 [2] also assigned to Spindler & Hoyer also discloses a system with mounts with apertures for receiving rods. Mounts with open apertures that can be snapped on to the rods are provided. A system supplied by Linos AG uses square mounting plates with apertures adjacent the corners, into which rods have to be passed. Mounting plates are also provided which have open apertures which can be latched onto rods. To construct an optical system, mounts are secured to an optical bench to support rods above the bench, and components are attached to the rods. The system includes open cubes, which have blind bores adjacent the corners of some faces, to receive the ends of rods. The components of the system are designed primarily to cooperate with the arrangement defined by the rods, above the optical table. A similar system from Thorlabs Inc uses “X” shaped mounts with apertures at the ends of the four arms to receive rods.

The known systems lack versatility and compatability.

### SUMMARY OF THE INVENTION

One aspect of the present system is based on the realisation that by attaching components to rods in a novel manner it is possible to manufacture components which will work with both fps and metric systems.

Thus, viewed from one aspect an invention disclosed provides an optical construction system including two rods which are to be positioned in a parallel arrangement, and a module having a pair of outwardly facing, open locating channels which are adapted to engage surfaces of the rods so as to locate the module between the rods, each locating channel being defined by a pair of perpendicular faces.

It should be noted that each channel may be continuous along its length, or could comprise a number of channel sections. There could be provided a pair of channel sections spaced apart by a substantial distance, for example. The perpendicular faces may be defined by relatively th sections such as flanges or by the end faces of relatively thick sections.

In a conventional metric system, 12 mm diameter rods may be attached to an optical table at 50 mm spacing. In a conventional fps system, rods of half inch (12.7 mm) diameter may be attached to an optical table at two inch (50.8 mm) spacing. The difference is such that a component provided with a pair of apertures to receive the rods, such as in the prior art discussed above, cannot work with both systems. However, in accordance with the present invention the module is located between the facing surfaces of the rods. The minimum spacing between the facing surfaces of two rods in the metric system described above is 38.0 mm and that between the rods in the fps system 38.1 mm. These two distances are sufficiently close for the same module to cooperate with the rods in both systems. By using channels defined by perpendicular faces, the module can cooperate with rods of different diameters, the faces engaging the rods tangentially.

By contrast, even in the prior art systems which have mounts with open apertures that can be placed over rods, the apertures and their positions must be correct for one type of rod and the mounts cannot be used with rods of a different type.

In one preferred arrangement, a configuration permitting location of a module within the space defined by rods will involve four parallel rods arranged at the corners of a square. The module will be in the general form of a cuboid—and in some embodiments a cube, although in some applications an elongate cuboid may be preferred-having four parallel channels, also arranged at the four corners of a square. Such an arrangement requires the module to be slid between the rods form one end, before that end is closed off in a suitable manner to keep the rods at the required positions. However, that restricts th e ability to add or remove modules once an optical system has been constructed. Thus, in another preferred arrangement, it is possible to insert a module laterally and this is achieved by omitting one of the four rods. To be located on the three remaining rods, it is only necessary for a module to have parallel channels at three of the four corners of a square, i.e. along the parallel edges of two adjoining faces of a cuboid.

In addition to mounting a module within a space defined by rods, it will be possible to mount them outside of his space. In that case, a module will be located on two rods, and the module will have two parallel channels, which will be along two parallel edges of one face of a cuboid.

In any of these cases, means are preferably provided to secure the module in position on the rods. In the case of a four rod system where a module is located within the space defined by the four rods, means should be provided to prevent axial movement of the module. In other arrangements, means must be provided to prevent both axial movement and movement of the module away from the rods. In a preferred embodiment, a securing plate is provided which is located on the side of two rods opposite that on which a module is mounted, the securing plate being releasably attached to the module by fastening means such as screws so as to clamp the module to the rods. The plate may be of generally rectangular shape, and preferably square to match the shape of the preferred cube shaped modules. Two opposing edges of a square plate, on the side which faces the module, may be provided with extensions that will engage the module and will limit the clamping force. With the plate in one orientation, the other two edges will face the rods directly. The limited clamping force, which may be zero in terms of restricting axial movement, will allow the axial position of the module to be adjusted With the plate turned trough a right angle, the two edges with extensions will face the rods directly, and securing the plate to the module can cause a tight clamping force to be generated to hold the module firmly in position.

Another aspect of the present system concerns the module for cooperating with the rods, which can act as a building block for constructing systems. This module can preferably be used to construct frameworks, and optical components such as lenses, mirrors, optical fiber system components, and so forth may be attached to the modules directly or by means of mirror mounts or the like. The building blocks are preferably capable of being used in a number of ways, with and without the rods. These include attaching the building blocks directly to each other, attaching them to vertical or horizontal rods, and attaching them directly to optical tables.

Viewed from one aspect of an invention disclosed herein, therefore, there is provided a module for constructing an optical system, comprising an open framework of generally cubic form, at least one side of the module being provided with a pair of open locating channels respectively positioned along two parallel edges, each locating channel being defined by a face which is parallel to said side of the module and a face which is perpendicular to said side of the module.

In a basic configuration with a pair of channels on one side only of the module, it can be attached to two rods in the manner described earlier. If two adjacent sides are provided with parallel pairs of channels—one channel being common to both sides—then the module can be used within the space defined by three rods as described earlier, or it can be attached to two rods in two alternative configurations. Such a module may be of particular use as a functional module which will carry components such as mounts, adjustment mechanisms and so forth. The remaining four sides of the module can be optimised to handle such functions, without the design restraint of providing the channels for locating with rods. Thus, the interior of the module may be adapted to contain an adjustable mounting mechanism, whilst some of the faces are specifically designed to receive a drive plate for actuating the mechanism.

It will be appreciated that the expression “open framework” used in relation to such a function module refers to the basic configuration of the module, and this is unaffected by the presence of any mechanisms or other objects within the module. It will also be appreciated that the module may not be a perfect cube in terms of exterior shape, either without any additional components or with them installed.

An alternative embodiment of module may serve a number of purposes, serving as a basic build block and also providing means for locating rods in a desired configuration. Such a dual purpose module is in the general form of a cube. However, whilst eight edges of the cube are provided with a channel as described above, four parallel edges are provided with extensions having means for receiving the ends of rods. Thus, such a module can be connected to rods in the manner described earlier, either received within a three or four rod arrangement or attached to two rods. However, it can also be used to accept up to four rods which will project from its corners, thus defining an arrangement of rods to which other modules can be attached.

Preferably, this type of module is adapted to be attached directly to an optical bench, either having for example apertures to use fasteners which can be screwed or otherwise attached to the bench, or being adapted to receive a joining element, such as a rotatable mount, which is in tun fixed to the optical bench in a manner that will be described below.

When this type of module has rods attached to it, then means must be provided to secure the other ends of the rods. If for example, the module has threaded bores to receive threaded portions of the rods, then in a preferred arrangement a base plate is provided at the other end of the rods, fasteners passing through the base plate and being accessible from the side remote from the rods. Such a base plate may be adapted to be joined to the modules described already, or to be attached to an optical bench. It may have, for example, apertures to use fasteners which can be screwed or otherwise attached to the bench, or be adapted to receive a joining element, such as a rotatable mount, which is in turn fixed to the optical bench in a manner that will be described below.

A basic module in accordance with the present inventive aspect may be in the form of a simple open framework defining a cube having six sides. Each side is preferably provided with four flanges projecting perpendicularly outwardly from the side, the flanges being arranged in a square. Thus, a channel will be defined between one flange of a side, and an adjacent perpendicular flange provided by another side. This type of module can be attached to rods in any desired configuration, either being within the space defined between rods or being attached to rods from the outside. The module can also be attached directly to an optical bench in the manner described below.

The sides of the modules, and in particular the faces defining the channels, may have apertures spaced along their length. These may be used to join the modules together. In some cases, junction blocks may be necessary to join modules together, these being secured by fasteners to apertures in each block. A feature of the preferred modules is that they are adapted to be joined directly together to form an optical system, so that rods are not essential. Such blocks can also be used to create variations of modules. For example, a basic module with channels along twelve edges can be converted to a functional module or to a dual purpose module by attaching blocks to certain edges.

This enables light to pass through the module via up to six sides; or for optical elements such as lenses, mirrors or prisms to be mounted inside the module; for supports and control mechanisms to be mounted inside or outside the module. In the preferred embodiment this cam be achieved by securing a mounting to the apertures in the perpendicular faces defining the channels along the edges of the module. The sides of the module may have simple square openings although e.g. circular openings could be used. The sides of square openings may assist in locating components to be attached to the module.

The module may be die cast from metal such as aluminium, for example. For less demanding use such as for use by children the module may be made from injection moulded plastics.

A junction piece for joining together modules may be in the form of an elongate cuboid with threaded apertures extending through the four longitudinal faces. Threaded fasteners can be used to fasten the connection piece to two adjacent modules.

The rods in the system do not have to be used in a vertical configuration, fixed directly to an optical table. They could be used horizontally and for such use a connector module may be provided to which the rods are attached, this connector module being secured to a module. The connector module may also be used to connect the rods to an optical table indirectly. The connector module is new and inventive in its own right. The rods may be in the form of solid rods or hollow tubes, preferably of metal such as steel.

As regards the manner in which a module may be attached directly to an optical table, without the use of the rods, this may involve the use of an adapter to which the module is attached, this in turn being secured to the standard apertures in the table. In one preferred arrangement, the adapter enables rotation of the module and preferably allows for eccentric movement. A preferred adapter is in the form of a cylindrical member which fits inside the module in the space bounded by members defining one side of the module. The module can thus rotate relative to the adapter, and a flange is provided to locate over the members defining the side of the cube. The adapter is provided with at least one aperture to permit a fastener to secure the adapter to an optical bench. There may be provided two or three apertures one being elongate. Such an adapter is new and inventive in its own right.

An advantage of the preferred system is that there are clearly defined spaces when an optical arrangement is constructed either with or without rods. One of these is “Beam Space” which is the space through which light travels and which may contain elements such as lenses and mirrors. Another is “Function Space”, which is the space within a module that contains e.g. mechanisms for holding and adjusting mirrors and other optical elements which will themselves be located within Beam Space. The third is “Operator Space”, which is where adjustments of mechanisms may be carried out by use of control knobs. In preferred arrangements using the current system, these three types of space are kept independent. For example, neither Function Space mechanisms nor Operator Space controls are within Beam Space. Thus, functional mechanisms do not interfere with Beam Space, and operators do not have to manipulate controls within Beam Space. This latter advantage not only avoids possible user interference with what is happening within Beam Space but also reduces the possibility for injury to an operator. This can be of particular importance when laser light sources are used.

The present invention extends, without limitations to:

(a) the system comprising rods and one or more of the modules;

(b) the various modules themselves;

(c) a system including a number of the modules joined directly together, the system optionally also including rods;

(d) a method of constructing an optical array using a system with rods and at least one of the modules; and

(e) a method of constructing an optical array using a system including a number of the modules joined directly together, the system optionally also including rods.

The present invention provides a system which is inexpensive and simple to manufacture and simple to use. There is the benefit that, in a preferred form, the same components can be used with standard optical tables and rods in either a metric or an fps format. However, there are very significant advantages in the preferred modules and the versatility with which they can be used together and with other components. It is simple for complex systems to be designed and constructed using the building blocks. The system is suitable for laboratory use and for product development, and even for the construction of products for use by customers.

The modules are such that a standard set of optical components can be connected to any one of up to six sides, although some modules may be configured to receive certain types of component on some sides only. A standard backing block module could be used, specifically designed to connect to the modules, which could constructed as a mirror mount, a beam splitter mount, a translation stage or a goniometer, for example.

One aspect of the invention relates to an optical construction system including: first and second rods which are to be positioned in a parallel arrangement; and a module having a pair of outwardly facing, open rod locating channels which are adapted to engage surfaces of the rods so as to locate the module between the rods.

Another aspect of the invention relates to an optical construction system including: first and second rods arranged parallel to each other and having respective first and second circumferential surfaces; and a module having first and second outwardly facing, open rod locating channels arranged to engage the first and second circumferential surfaces of the rods respectively, so as to locate the module between the rods.

Another aspect of the invention relates to a module for an optical construction system, the module comprising: a first rod locating channel; and a second rod locating channel arranged facing away from the first rod locating channel and separated from the first rod locating channel by a spacing of between 38.0 and 38.1 mm, thereby to allow location of the module both by a pair of rods of 12 mm diameter separated by 50 mm and by a pair of rods of ½ inch diameter separated by 2 inches. The module may further comprise third and fourth rod locating channels arranged with the first and second rod locating channels to form a square grid, so that adjacent pairs of the first through fourth rod locating channels are separated by a spacing of between 38.0 and 38.1 mm. The module may also further comprise third through twelfth rod locating channels arranged with the first and second rod locating channels to form a cubic grid, so that adjacent parallel pairs of the first through twelfth rod locating channels are separated by a spacing of between 38.0 and 38.1 mm.

Another aspect of the invention relates to a module for constructed an optical system, comprising an open framework of generally cubic form, at least one side of the module being provided with a pair of open locating channels respectively positioned along two parallel edges, each locating channel being defined by a face which is parallel to said side of the module and a face which is perpendicular to said side of the module.

Another aspect of the invention relates to an optical construction method comprising: securing at least fist and second rods having respective first and second circumferential surfaces to an optical mount having a pitch so that the rods are secured to extend parallel to each other; providing a module having first and second rod locating channels facing away from each other; and engaging the module with the first and second rods by receiving the first and second rods into the first and second rod locating channels. Each rod locating channel may be defined by a pair of perpendicular faces, one of each pair being strained by the step of engaging the module with the first and second rods, thereby to hold the module between the rods. The second rod locating channel may be separated from the first rod locating channel by a spacing of between 38.0 and 38.1 mm, thereby to allow location of the module both by a pair of rods of 12 mm diameter separated by a pitch of 50 mm and by a pair of rods of ½ inch diameter separated by a pitch of 2 inches.

Further aspects of the invention are exemplified by the attached claims.

### BRIEF DESCRIPTION OF THE DRAWINGS

For a better understanding of the invention and to show how the same may be carried into effect reference is now made by way of example to the accompanying drawings in which:

FIG. 1a is a diagram showing the dimensions and spacings of rods in an fps system;

FIG. 1b is a diagram showing the dimensions and spacings of rods in a metric system;

FIGS. 1c and 1d are diagrams showing how, in accordance with the invention, a single component can be mounted between the rods in either an fps or a metric system;

FIG. 2 is a perspective view of a cubic module in accordance with the invention;

FIG. 3 is a plan view showing how the cubic module can be mounted between four rods;

FIG. 4 is a perspective view of an alternative module in accordance with the invention;

FIG. 5 is a perspective view of a second alternative module in accordance with the invention;

FIG. 6 is a perspective view of a connector block for use in a system in accordance with the invention;

FIG. 7 is a perspective view showing how the modules of FIGS. 3, 4 and 5 may be connected directly together;

FIG. 8 is a perspective view of a connector module for use with components in accordance with the invention;

FIG. 9 is an underneath perspective view of the connector module of FIG. 8;

FIG. 10 is a perspective view showing how the connector module of FIGS. 8 and 9 may be connected to another module and to rods;

FIG. 11 is a perspective view of an adapter for use in a system in accordance with the invention;

FIG. 12 is an underneath perspective view of the adapter;

FIG. 13 shows how the adapter may cooperate with a module;

FIG. 14 is a peeve view of a plate for clamping a module to rods;

FIG. 15 shows the clamping plate used to connect a module to two rods;

FIG. 16 shows how a module may be clamped to two rods; and

FIGS. 17 and 18 show an example of how various components may be used together to build a optical system.

### DETAILED DESCRIPTION

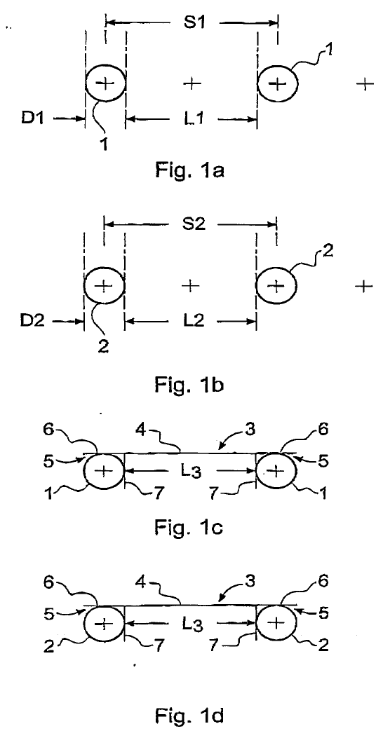

Referring now to FIG. 1a, there are shown two rods 1 used in an fps system. The rods are of circular cross section and have a diameter D1 of half an inch (12.7 mm). They are attached to an optical table which has apertures at one inch (25.4 mm) spacing. As shown they are attached at a spacing S1 of two inches (50.8 mm). This means that the distance L1 between their facing surfaces is 38.1 mm. FIG. 1b shows two rods 2 used in a metric system. The rods are of circular cross section and have a diameter D2 of 12 mm. They are attached to an optical table which has apertures at 25 mm spacing. As shown they are attached at a spacing S2 of 50 mm. This means that the distance L2 between their facing surfaces is 38.0 mm. Thus, the difference between L1 and L2 is 0.1 mm and in the context of the present system this is acceptable for a standard component to be located between the rods 1 or the rods 2. This component 3 is shown diagrammatically in FIGS. 1c and 1d. It comprises an elongate portion 4 which in this case is constructed to have a length L3 of just less than 38 mm, the minimum spacing between the rods, and in this embodiment the length is between 37.75 mm and 37.95 mm. At both ends it is provided with a channel 5 which is defined by two faces 6 and 7. Face 6 is a direct extension of elongate portion 4, and face 7 extends perpendicularly to it. These two faces engage the surfaces of the rods 1 and 2 so as to locate the component 3. In this arrangement, there is only location in respect of longitudinal movement and one degree of lateral movement. However, in a preferred embodiment of the present invention, a number of such components are combined and cooperate to locate a module in all desired directions.

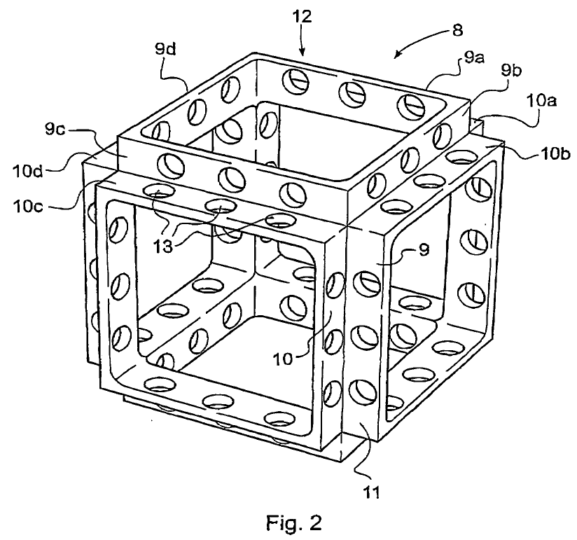

FIG. 2 is a perspective view of such a module 8. The module is in the form of a framework defining the edges of a cube. The module may be die cast from aluminium or made in any other way, and from any other material, as may be desired. Each of the twelve edges of the module 8 is identical and constituted by an identical pair of flanges 9, 10 which are extensions of the faces of the cube and are perpendicular to each other. Each pair of flanges 9, 10 defines an outwardly open channel 11 extending along the corresponding edge of the cube. The interior of the cube is hollow and the faces are open. Any face is defined by four flanges forming a square, such as face 12 defined by flanges 9a, 9b, 9c and 9d. Extending at right angles from the bases of these flanges 9a to 9c are flanges 10a, 10b, 10c and 10d. Viewed in the direction of face 12, there are four parallel open channels extending at right angles to the face 12, one at each corner, as exemplified by the channel 11. This arrangement is repeated for each of the six faces of the module. Each of the flanges making up the module, twenty four in total, is provided with three apertures 13 spaced along its length, to receive fasteners for securing the module to like modules or to other components. Each flange making up the module has a length of just under 38.0 mm, for example being in the range of 37.75 mm to 37.95 mm.

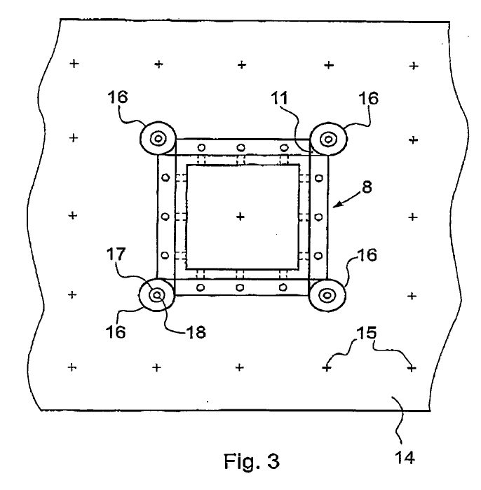

In FIG. 3 there is shown an optical table 14 with threaded apertures 15 arranged on a square grid, for example at 25 mm spacings. Four vertical steel rods 16 of circular cross section are secured to the optical table at the corners of a 50 mm square. Each rod is 12 mm in diameter. Each rod 16 will have, for example, a threaded recess 17 at both ends which can receive projecting threaded fasteners 18. The fasteners at the lower ends, not shown, are received in the corresponding threaded apertures 15 of the table 14.

A module 8 is located within the space defined by the rods 16, with vertical channels 11 receiving the rods 16. The configuration between two rods corresponds to that illustrated in FIGS. 1c and 1d, and in this arrangement the module 8 is located against horizontal movement in all directions. The dimensions are chosen so that it is possible to slide the module into position. It is possible for the identical module 8 to be used with an optical table having apertures at one inch (25.4 mm) spacing and rods of half inch (12.7 mm) diameter. The cube can still be slid into position in the manner shown and will still be located in a sufficiently secure manner as regards movement in horizontal directions.

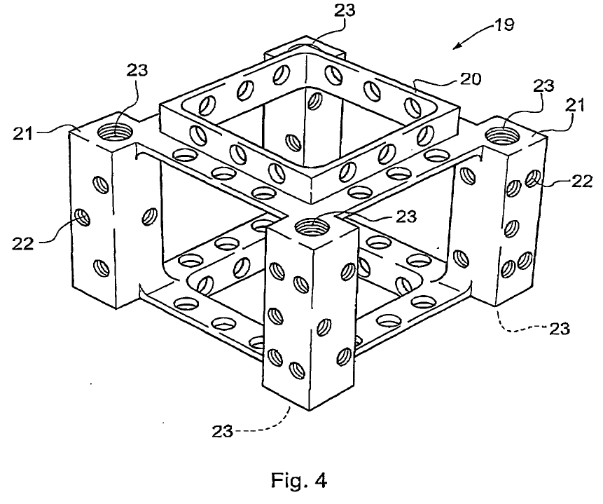

FIG. 4 shows an alternative type of module 19 which in some respects is more versatile than the module 8. This has the same underlying cubic configuration with apertured flanges 20. However, along four parallel edges are provided integral blocks 21. These have threaded bores 22 to receive fasteners so that the blocks can be secured to other components but also have axial threaded bores 23 at both ends, which can be connected to rods and thus increase the versatility of the system.

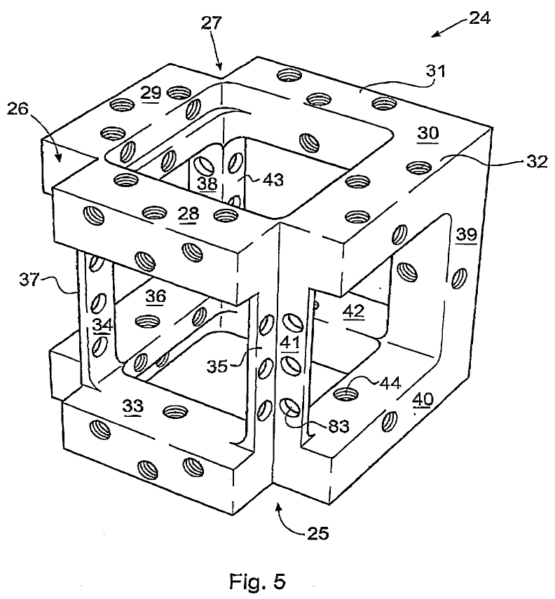

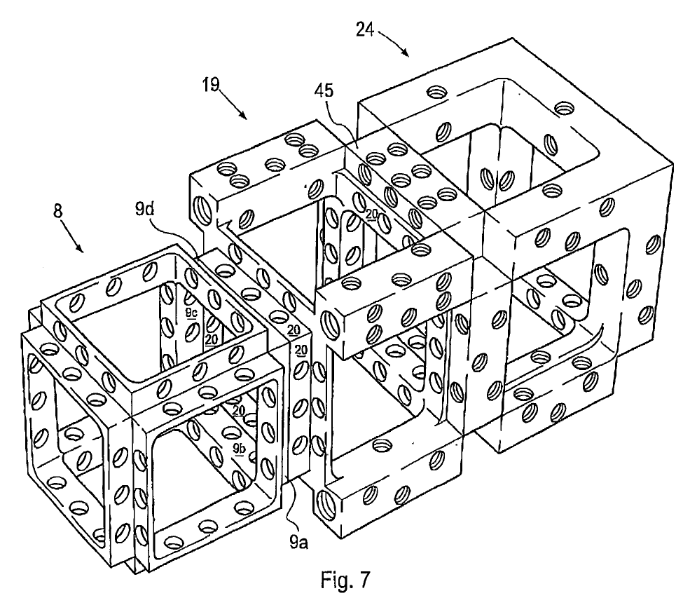

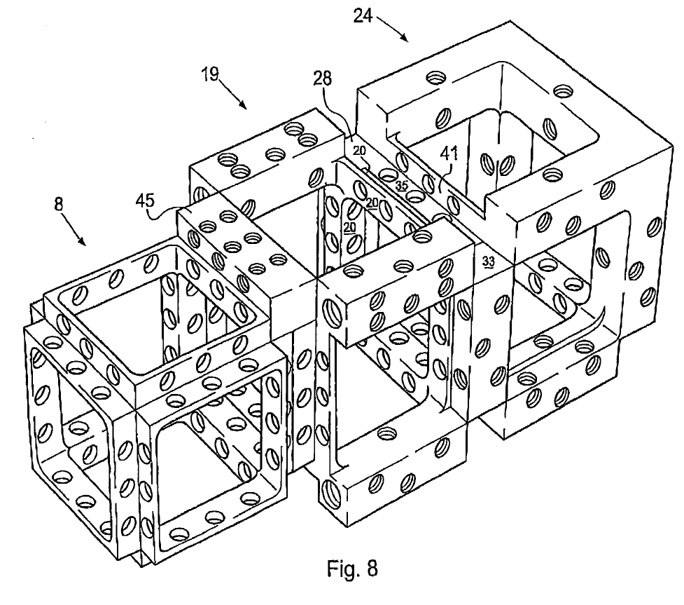

FIG. 5 shows a second type of alternative module 24 which is designed specifically to receive functional components such as drive operating controls on outer faces, and drive mechanisms in the interior space. Again is has the same underlying cubic configuration of the module 8, but many of the edges have been replaced by integral blocks, leaving only three parallel channels 25, 26 and 27, defined in their middle parts by flanges and at their ends by faces of blocks. The module 24 is also shown in FIGS. 7 and 8. The upper face, as viewed in FIG. 5, has blocks 28 and 29 on the front and left sides, and a solid “L” 30 formed by integrally connected blocks 31 and 32 on the rear and right sides. The front face has the block 28 at its top end and a block 33 at its bottom end, these being joined by flanges 34 and 35. The left hand face matches the front face with block 29 and a block 36 joined by flanges 37 and 38. The right band face is formed essentially as a solid “U”, with block 32, a block 39, and a block 40 all integrally formed. The ends of the “U” between blocks 32 and 40 are joined by a flange 41. The rear face is of the same configuration as the front face, with a solid “U” formed by the blocks 31, 39 and a block 42. The ends of the “U” are joined by a flange 43. Finally, the bottom face matches the top face, with a solid “L” defined by blocks 40 and 42, and the two blocks 33 and 36. All of the flanges are provided with apertures, e.g. 83, and all of the blocks are provided with threaded bores, e.g. 44, to assist in connection to other components.

It will be seen that there is a solid part of this module, defined by integral blocks 31, 32, 39, 40 and 42 defining two faces with solid “L's” and two faces with solid “U's”. This increases the rigidity of the module and provides a solid foundation for drive mechanisms and so forth to be connected to these faces, either externally or mounted within the module.

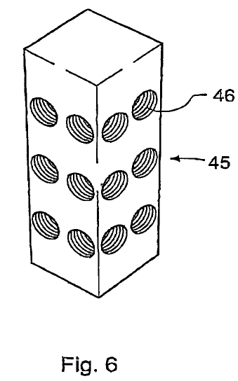

FIG. 6 shows a connector block 45 which can be attached to any of the modules to connect them together or to other components. The block is provided with threaded bores, e.g. 46, along its four longitudinal edges. By connecting a number of these blocks 45 to the flanges of basic module 8, it is possible to fabricate the more complex modules 19 and 24.

FIG. 7 shows how the modules 8, 19 and 24 may be joined together. This is for the purposes of demonstration only, to illustrate available options, and does not necessarily represent what a user would construct in practice. Fasteners have been omitted. As shown in FIG. 7, the flanges 9a, 9b, 9c and 9d on module 8 abut flanges 20 on module 19. One set of the abutting flanges is shown joined together by means of a connecting block 45 and threaded fasteners passing through apertures in the flanges. In practice, this would be matched by a corresponding block on the lower abutting flanges. FIG. 7 also shows modules 19 and 24 joined together. Vertical flanges 20 on module 19 slot between blocks 28 and 33 of the module 24. Fasteners will be used through appropriate apertures and bores so that the vertical flanges 20 of module 19 are secured directly to the blocks 28 and 33 of module 24. Connecting blocks 45 are not needed for joining together modules 19 and 24 although they might be used in certain circumstances.

It will be appreciated that by using the same principles, the modules can be joined to each other in many combinations, either directly or by using a connector block 45, and changing direction horizontally, vertically or laterally.

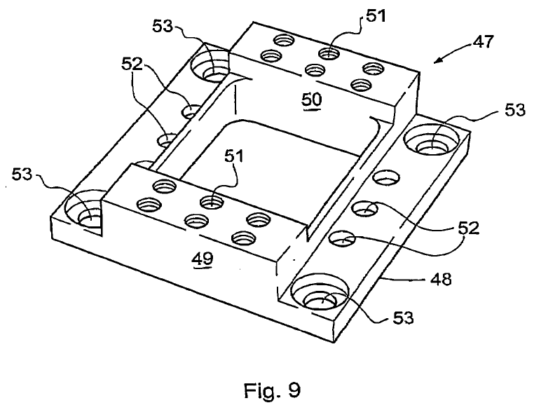

FIGS. 8 and 9 show a connector plate 47 which is designed to connect rods 16 to other components of the system. The connector plate consists of a base 48, with blocks 49 and 50 on two opposing sides. Threaded bores 51 are formed in the blocks, and apertures 52 are provided on the other two opposing sides. The sizes of the blocks and the positions of the bores and apertures are such that this connector plate 47 can be joined to modules of the system either directly or by the use of a connector block 45. The corners of the plate are provided with bores 53 adjacent each corner, which are countersunk from each direction. In use, fasteners will pass through the bores and into threaded bores in the ends of rods for use in the system.

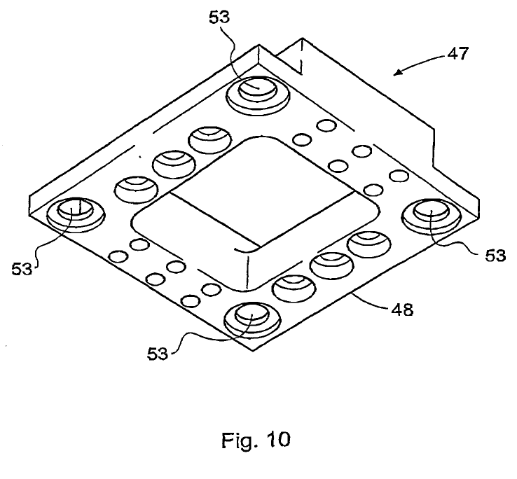

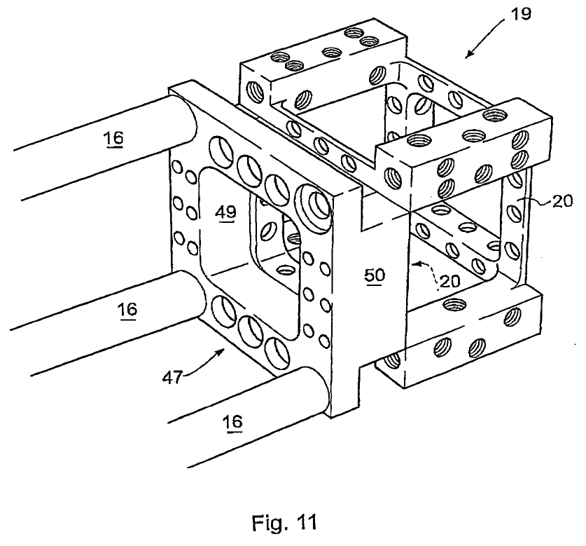

FIG. 10 shows how the connector plate can be used to connect three rods 16 to a module 19. In this case, the blocks 49 and 50 are fastened directly to flanges 20 of module 19. The other ends of the rods 16 could be supported in a similar manner, or could be attached directly to the axial bores 23 of blocks 21 of a module 19. In a vertical configuration, the other ends of the rods 16 could be fastened directly to an optical table, for example.

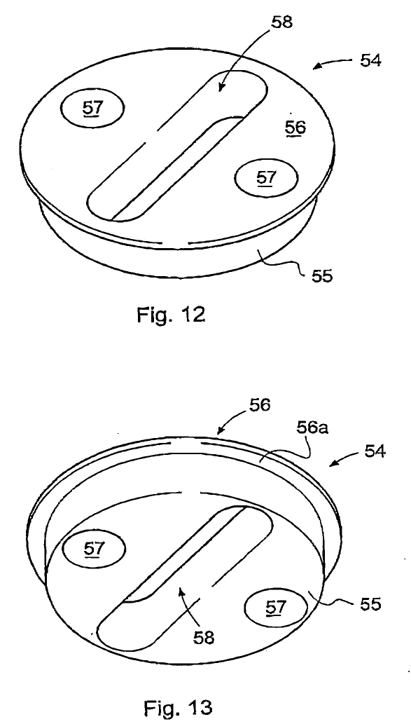

FIGS. 12 and 13 show an adapter 54 for se a module such as 8 or 19 directly to an optical table. The adapter 54 has a first cylindrical portion 55 of circular cross section whose diameter is slightly less than the sides of the square defined by the inner surface of the flanges of the module 8 or 19 at one face. The adapter also has a circular head 55 defining a flange 56 whose diameter is such that it will rest on the flanges around the face, but is smaller than the diagonal of the opening at a face so that the adapter 54 can be placed into the module 8 or 19. The adapter 54 is provided with two circular apertures 57 and an elongated aperture 58.

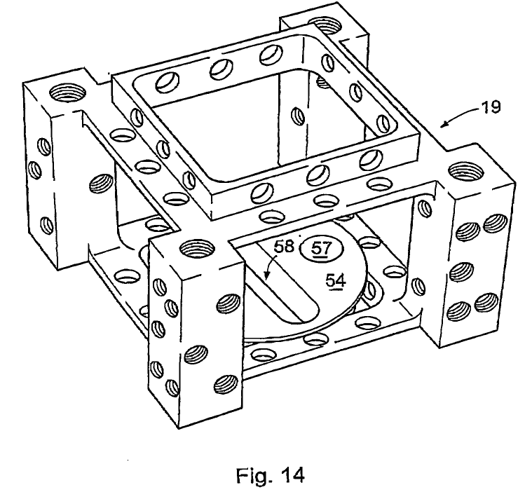

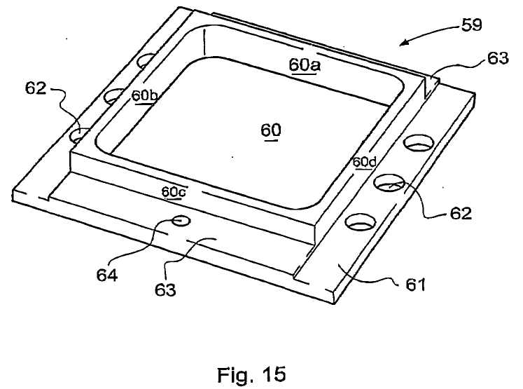

FIG. 14 shows how the adapter 54 can be positioned inside a module 19, so that the adapter can be secured to an optical table by means of a threaded fastener passing through appropriate apertures 57 and/or 58 into a threaded bore of the optical table. With this arrangement, rotational adjustment of the module 19 is possible before the fastener is tightened. By using elongate aperture 58, rotational and translational adjustment are possible. Rods 16 can be attached to the module 19, extending vertically, and the ability to rotate and translate the assembly as a whole provides greater versatility tan connecting the rods directly to bores in the optical table.

FIG. 14 shows a clamping plate 59 for connecting a module to rods 16. If a module is received within four rods as shown in FIG. 3, then clamping may be necessary to restrict axial movement. However, in a number of arrangements it will be preferred to attach a module to only two or three rods, so that there is better access to the module. In such cases, the clamping arrangement must also resist lateral movement. The clamping plate consists of a square, hollow central region 60 formed by upstanding flanges 60a, b, c, and d, whose dimensions are such that the central region can pass into the spaces between flanges and blocks in modules such as 8, 19 or 24. The central region 60 is surrounded by a flange 61. On two opposing sides, apertures 62 are provided to cooperate with bores in flanges or blocks of the modules, so that the plate can be attached to a module, thus clamping one or more rods between the clamping plate and the module. On the other two opposing sides, raised regions 63 are provided, and these each have a bore 64 for cooperation with the module. If the plate is clamped against a module using these two sides, the raised region will restrict the extent to which clamping against rods between them can be effected. This is useful if there has to be continual, approximate adjustments of position as a system is being set up. Once the required positions are known more clearly, the plate can be unfastened, rotated through a right angle and re-fastened in the exact position with a full clamping force.

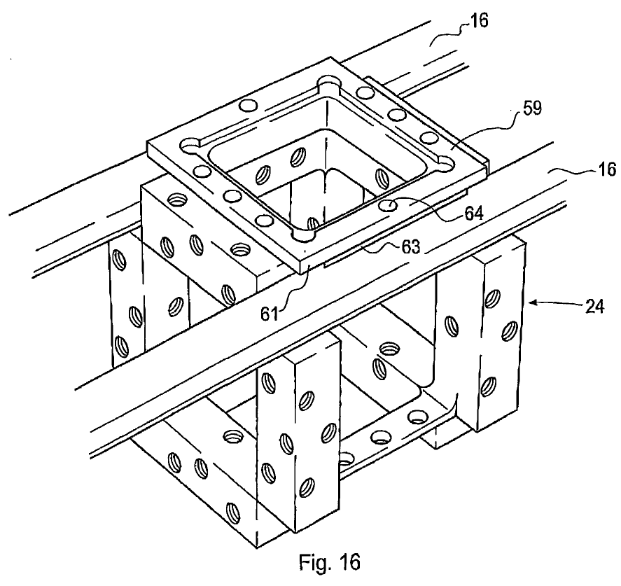

FIG. 16 shows how a module 24 may be clamped to two rods 16 in the above manner. Fasteners have been omitted for clarity.

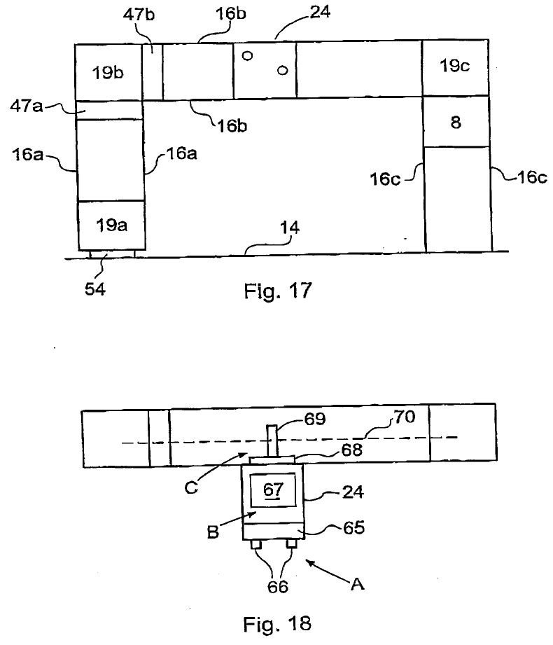

FIGS. 17 and 18 show one manner in which the various components may be used together, these FIGS. being diagrams in which the detailed structure of the components has been omitted, and practical optical functions have been ignored.

In these figures there is shown an optical table 14. On one side of his is mounted an adapter 54, to which is connected a module 19A. Four rods 16A are connected directly to the module 19A, and extend upwards to a connector plate 47A. In turn the connector plate is connected to a further module 19B, a second connector plate 47B, and then three rods 16B. These three rods 16B extend across to another module 19C, to which they are connected directly. This module 19C is connected directly to a module 8, which is received within the space defined by four rods 16C which are connected directly to the optical table 14. In this arrangement, modules 19 A, B and C are identical to module 19 described earlier, connector plates 47A and B are identical to connector plate 47, and rods 16A, B and C are identical to rods 16.

Along rods 16B is mounted a function module 24. On this is mounted a drive control unit 65 with manual adjusters 66. Within the module 24 is mounted a drive adjusting mechanism 67. This alters the position of a lens mounting plate 68, on which is mounted a lens 69. A beam of light which passes through the lens is indicated by the dotted line 70. FIG. 18 illustrates of the separation of the system into three “Spaces”. Operator Space is indicated generally at “A” and includes the manual adjusters 66. Function Space “B” is whithin the module 24 and includes the adjusting mechanism 67. Beam Space “C” is within the region bounded by the rods 16B and includes the lens 69.

In summary, a general problem with optical component systems is the prevalence of two separate standards, the metric standard and the Imperial standard. Both standards are well established and there is no prospect of one standard dominating in the forseeable future. In the metric standard, optical tables, breadboards and other items are provided with square grids having a 50 mm pitch (or 25 mm). In the Imperial standard, the pitch is instead 2 inches (or 1 inch). Optical rail systems, cage assembly systems and the like thus have to be specifically manufactured for each standard. The invention builds on the fact that in the metric system, the optical rods used have a diameter of 12 mm (radius 6 mm), whereas in the Imperial system they have a diameter of ½ inch (radius ¼ inch). Based on this fact, the realisation has been made that the separation between the outer surfaces of two rods mounted on adjacent holes is almost the same for both standards for the special case of the comparison between 2 inch and 50 mm rod separation. That is, quite fortuitously, 2 inches less twice ¼ inch, which equals 1 ½ inches (=38.0 mm), is almost the same as 50 mm less twice 6 mm, which is 38.0 mm. As a result, it has been possible to design a single optical module that can be accommodated both by the Imperial and metric systems, thus providing a great rationalisation in terms of manufacturing and user considerations.

It will thus be seen that the present invention provides a versatile optical system construction system, with efficient and effective mounting of components Depending on the availability, expense and suitability of materials, the various components of the system may be made from metals, plastics, ceramics or composites, for example.

### REFERENCES

[1] U.S. Pat. No. 3,945,600

[2] U.S. Pat. No. 5,035,333

1. An optical construction system including:
first and second rods arranged parallel to each other and having respective first and second circumferential surfaces; and
a module having first and second outwardly facing, open rod locating channels, each having a pair of perpendicular faces arranged to tangentially engage the first and second circumferential surfaces of the rods respectively, so as to locate the module between the rods.

2. The system of claim 1, wherein the locating channels are separated from each other by a spacing of between 38.0 and 38.1 mm, thereby to allow location of the module both by a pair of rods of 12 mm diameter separated by 50 mm and by a pair of rods of ½ inch diameter separated by 2 inches.

3. A module for constructing an optical system, comprising an open framework of generally cubic form, at least one side of the module being provided with first and second open rod locating channels respectively positioned along two parallel edges, each rod locating channel being defined by a face which is parallel to said side of the module and a face which is perpendicular to said side of the module.

4. The module of claim 3, wherein the second rod locating channel is arranged facing away from the first rod locating channel and separated from the first rod locating channel by a spacing of between 38.0 and 38.1 mm, thereby to allow location of the module both by a pair of rods of 12 mm diameter separated by 50 mm and by a pair of rods of ½ inch diameter separated by 2 inches.

5. The module of claim 4, further comprising third and fourth rod locating channels arranged with the first and second rod locating channels to form a square grid, so that adjacent pairs of the first through fourth rod locating channels are separated by a spacing of between 38.0 and 38.1 mm.

6. The module of claim 4, further comprising third through twelfth rod locating channels arranged with the first and second rod locating channels to form a cubic grid, so that adjacent parallel pairs of the first through twelfth rod locating channels are separated by a spacing of between 38.0 and 38.1 mm.

7. An optical construction method comprising:
securing at least first and second rods having respective first and second circumferential surfaces to an optical mount having a pitch so that the rods are secured to extend parallel to each other;
providing a module having first and second rod locating channels facing away from each other and each having a pair of perpendicular faces; and
engaging the module with the first and second rods by receiving the first and second rods into the first and second rod locating channels so that the pairs of faces of the first and second rod locating channels tangentially engage the first and second circumferential surfaces of the first and second rods.

8. The method of claim 7, wherein one of each pair of perpendicular faces is strained by the step of engaging the module with the first and second rods, thereby to hold the module between the rods.

9. The method of claim 7 or 8, wherein the second rod locating channel is separated from the first rod locating channel by a spacing of between 38.0 and 38.1 mm, thereby to allow location of the module both by a pair of rods of 12 mm diameter separated by a pitch of 50 mm and by a pair of rods of ½ inch diameter separated by a pitch of 2 inches.
